(19) United States
(12) Patent Application Publication
(10) Pub. No.: US 2007/0195112 A1
(43) Pub. Date: Aug. 23, 2007

(54) High resolution display apparatus and methods

(76) Inventor: Shraga Gibraltar, Haifa (IL)

Correspondence Address: DR. MARK FRIEDMAN LTD.;C/o Bill Polkinghorn, 9003 Florin Way, Upper Marlboro, MD, 20772, US

(21) Appl. No.: 11/704,306

(22) Filed: Feb. 9, 2007

(30) Foreign Application Priority Data
Feb. 9, 2006 (IL) 173634

(51) Int. Cl. G09G 5/00

(52) U.S. Cl. 345/648

(57) ABSTRACT

A combined-resolution display system including a surface for displaying images; a first display device adapted to display a first image, having a first resolution, on substantially all of the surface; at least one second display device adapted to display a second image having a second resolution greater than the first resolution, the second image being a representation of a region included in the first image, the second image displayable within a frame displayable on a portion of the surface in spatial registration with the first image so as to produce a combined mixed resolution image on the surface; and a registration subsystem adapted to coordinate operation of the first display device and the at least one second display device and to maintain registration between the respective images, aligning the second image within the first image while allowing at least one of: the frame being translated; the frame being rotated; the contour of the frame being changed; and the dimensions of the frame being changed.

### FIELD AND BACKGROUND OF THE INVENTION

The present invention relates to high resolution displays and, in particular, it concerns combined high and normal resolution projection work displays and methods thereof.

It is known that current workstation format displays used for computer work and other related applications are limited to relatively low resolutions, expressed by a total pixel count, currently ranging from about less than 1 to about 2 Megapixels. The limiting resolution capability of the human eye at a viewing distance of approximately 45 cm for a standard work format, such as 17 and 19-inch display formats, for example, is far in excess of such display resolutions by approximately an order of magnitude. By contrast, most printed material, ranging from 300 dot-per-inch (dpi) resolution and higher, printed on a typical letter-size or A4 page, and professional photographs printed on a typical 8×10-inch format, have equivalent pixel count resolutions ranging from approximately 10 to 100 Megapixels. These values exceed the limiting pixel count resolution capability of the human eye. This is the primary reason why such printed materials are typically considered as having true high resolution, as opposed to the lower resolution of so-called current “high resolution” displays.

One method used to increase display resolution is to employ a number of display devices (LCD, CRT display, etc.) or Barko projectors, each device/projector configured to display a portion of the overall display region or image. By coordinating respective devices/projectors a high resolution mosaic-like visual representation is created. Hereld et al., in an article entitled “DottyToto: A measurement engine for aligning multi-projector display systems”, whose disclosure is incorporated herein by reference, discusses this technique and considerations regarding smooth presentation of a visual representation derived from multiple projectors.

While methods of combining display devices to obtain a higher resolution image are useful, image resolution has been intrinsically limited to the display device itself, and high resolution imaging has not heretofore been generally suited for typical workstation display formats.

In addition to the considerations of overall display resolution discussed hereinabove, there exists an additional consideration of simultaneous viewing of two or more visual representations of a scene or objects, displayed at two or more different resolutions. Such a consideration is important for viewing, inter alia, topographical information and design objects with varying levels of detail and resolution. One method known in the art is to employ one or more displays, each having a different resolution, to display separate parts of the image. A shortcoming of this method, in addition to the additional displays and the space they occupy, is that the viewer must shift his view from one display to the other in order to grasp all of the information.

Another approach is disclosed by Baudisch et al. in US Patent Application Publication no. 2002/0167458, whose disclosure is incorporated herein by reference, wherein a system utilizing two or more display units with different resolutions are combined such that the geometry of images displayed across the multiple display units is preserved and the image appears to be substantially continuous to a viewer. Baudisch et al. disclose the use of various image processors and image replicators to feed a flat display, such as an LCD display, and a projector to display an image which appears to be combined and substantially continuous. Further details are given for methods to create a perceived continuous combined multi-resolution image in an apparent one-display surface (such as derived from a combined substantially coplanar display surface comprising, for example, an LCD display and a screen, upon which another resolution is projected).

There is therefore a need for a more easily implemented high resolution display system that allows simultaneous viewing of an entire scene with one or more zoomed and variable high resolution portions of the entire scene or a display system that allows substantially higher resolutions than currently available—all on a standard workstation format.

### SUMMARY OF THE INVENTION

The present invention relates to high resolution displays and, in particular, it concerns combined high and normal resolution projection work displays and methods thereof.

According to the teachings of the present invention there is provided a combined-resolution display system including a surface for displaying images; a first display device adapted to display a first image, having a first resolution, on substantially all of the surface; at least one second display device adapted to display a second image having a second resolution greater than the first resolution, the second image being a representation of a region included in the first image, the second image displayable within a frame displayable on a portion of the surface in spatial registration with the first image so as to produce a combined mixed resolution image on the surface; and a registration subsystem adapted to coordinate operation of the first display device and the at least one second display device and to maintain registration between the respective images, aligning the second image within the first image while allowing at least one of: the frame being translated; the frame being rotated; the contour of the frame being changed; and the dimensions of the frame being changed. Most preferably, the registration subsystem is further adapted so that the at least one of: the frame being translated; the frame being rotated; the contour of the frame being changed; and the dimensions of the frame being changed is optomechanically performed. Preferably, the registration subsystem is further adapted so that the at least one of: the frame being translated; the frame being rotated; the contour of the frame being changed; and the dimensions of the frame being changed is performed using image processing. Typically, the registration subsystem is further adapted so that the at least one of: the frame being translated; the frame being rotated; the contour of the frame being changed; and the dimensions of the frame being changed is performed optomechanically and using image processing.

There is also provided a combined-resolution display system including a surface for displaying images; a first display device adapted to display a first image, having a first resolution, on substantially all of the surface; at least one second display device adapted to display a second image having a second resolution greater than the first resolution, the second image being a representation of a region included in the first image, the second image displayable on a portion of the surface in spatial registration with the first image so as to produce a combined mixed resolution image on the surface; and a varying resolution subsystem adapted to coordinate operation of the first display device and the at least one second display device so that the resolution of the second image may be varied, while maintaining registration between the respective images, aligning the second image within the first image. Typically, the second resolution is at least two times larger than the first resolution.

There is further provided a combined-resolution display system including a surface for displaying images a first display device adapted to display a first image, having a first resolution, on substantially all of the surface; a first display device adapted to display a first image, having a first resolution, on substantially all of the surface; at least one second display device adapted to display a second image having a second resolution at least two times larger than that of the first resolution, the second image being a representation of a region included in the first image, and the second image is displayable on a portion of the surface in spatial registration with the first image so as to produce a combined mixed resolution image on the surface.

There is also provided a high resolution display system including a surface for displaying images; a first display device adapted to display a first image on substantially all of the surface; at least one second display device adapted to display a second image, wherein the second image is aligned with the first image, having a non-zero sub-pixel offset; and an offset control subsystem adapted to coordinate optoelectronic operation of the first display device and the at least one second display device so that a combined high resolution image is displayable on the surface. Most preferably, the first display device and the at least one second display device are projectors.

There is further provided a method of displaying combined-resolution images on a surface including the steps of: providing a first display device to display a first image, having a first resolution, on substantially all of the surface; using at least one second display device to display a second image having a second resolution greater than the first resolution, the second image being a representation of a region included in the first image; displaying the second image within a frame displayed on a portion of the surface in spatial registration with the first image so as to produce a combined mixed resolution image on substantially all of the surface; and coordinating operation of the first display device and the at least one second display device and maintaining registration between the respective images, aligning the second image within the first image while allowing at least one of: translation of the frame; rotation of the frame; changing the contour of the frame; and changing the dimensions of the frame.

There is additionally provided a method of displaying combined-resolution images on a surface including the steps of providing a first display device to display a first image, having a first resolution, on substantially all of the surface; using at least one second display device to display a second image having a second resolution greater than the first resolution, the second image being a representation of a region included in the first image; displaying the second image on a portion of the surface in spatial registration with the first image so as to produce a combined mixed resolution image on the surface; and coordinating operation of the first display device and the at least one second display device so that the resolution of the second image may be varied, while maintaining registration between the respective images, aligning the second image within the first image.

There is further provided a method of displaying combined-resolution images on a surface including the steps of: providing a first display device to display a first image, having a first resolution, on substantially all of the surface; using at least one second display device to display a second image having a second resolution that is at least two times larger than the first resolution, the second image being a representation of a region included in the first image; and displaying the second image on a portion of the surface in spatial registration with the first image so as to produce a combined mixed resolution image on the surface.

There is also provided a method of displaying high resolution images on a surface including the steps of: providing a first display device to display a first image on substantially all of the surface; using at least one second display device to display a second image, wherein the second image is aligned with the first image, having a non-zero sub-pixel offset; and coordinating optoelectronic operation of the first display device and the at least one second display device with an offset control subsystem so that a combined high resolution image is displayed on the surface.

### BRIEF DESCRIPTION OF THE DRAWINGS

The invention is herein described, by way of example only, with reference to the accompanying drawings, wherein:

FIG. 1 is a view of an image having a sub-image identified and the sub-image separately displayed schematically as a higher resolution sub-mage in accordance with an embodiment of the current invention; and

FIG. 2 is a schematic diagram of a combined-resolution display work format system, in accordance with an embodiment of the current invention; and

FIGS. 3 and 4 are schematic side views of parts of the combined-resolution display work format system shown in FIG. 2, in accordance with an embodiment of the current invention; and

FIG. 5 is a schematic diagram of a high resolution display system, in accordance with an embodiment of the current invention.

### DESCRIPTION OF THE PREFERRED EMBODIMENTS

The principles and operation of a high resolution display apparatus and methods according to the present invention may be better understood with reference to the drawings and the accompanying description.

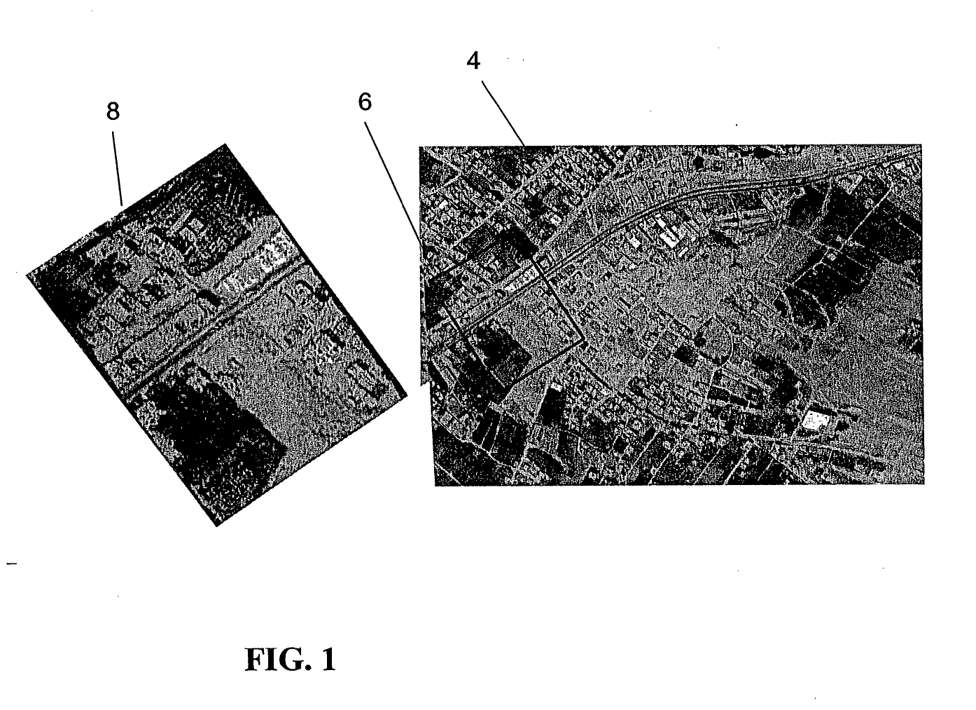

Referring now to the drawings, FIG. 1 is a view of an image 4 having a sub-image 6 identified and the sub-image separately displayed schematically as a higher resolution sub-mage 8. Image 4 is typically displayed by a display device (not shown in the figure) in a fixed display format. The display resolution of image 4, typically that of a “low resolution” image, corresponds to a pixel count of less than 1 to about 2 Megapixels at a viewing distance of approximately 45 cm for a typical 17 and 19-inch display format.

Note that whereas conventional display resolutions are frequently expressed in terms of dpi, usually meaning a fixed, limiting value, the word “resolution” used hereinbelow when referring to a display is used to express an absolute value of pixels per inch (i.e. “linear pixel density”), which may increase or decrease, either by increasing or decreasing the number of pixels in a given display area, or by either decreasing or increasing a given display area for a fixed number of pixels viewed. Furthermore, pixels need not necessarily have a square shape, so that a linear pixel density of a display area display is not necessarily equal along the primary axes of the display or the primary axes an area within the displayed image.

Frequently, it is desirable for a portion of image 4, which is identified as sub-image 6, to be displayed at a higher resolution than that of image 4. Higher resolution sub-image 8 can be displayed at such a higher resolution. Embodiments of the current invention described hereinbelow include apparatus and methods for simultaneous inclusion and display of higher resolution sub-image 8 within image 4 in a combined-resolution image.

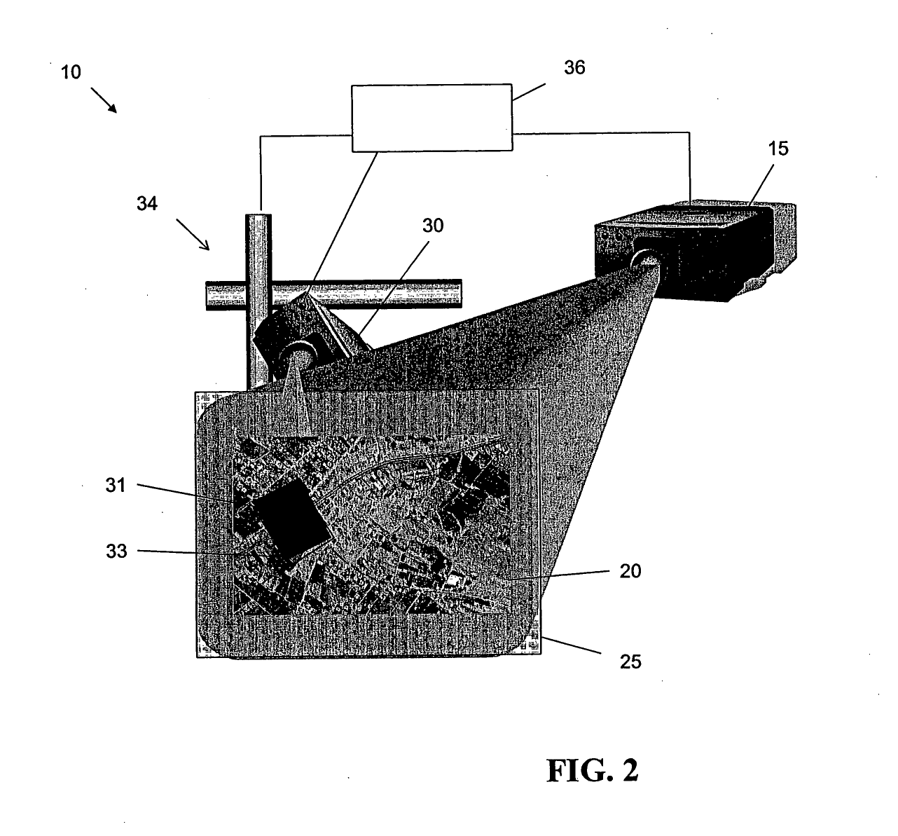

Reference is now made to FIG. 2, which is a schematic diagram of a combined-resolution display work format system 10, in accordance with an embodiment of the current invention. Combined-resolution display work format system 10 includes a full image display device 15 which displays a full image 20 onto a work format surface 25. A second display device 30, mounted on precision gimbals 34, displays a high resolution sub-image 31 (not shown) enclosed in a frame 33 (partially and schematically indicated in the figure), all displayed within full image 20. “Frame” as used herein is the delimiting border of the region of sub-image 31, of the combined-resolution image, displayed onto surface 25. In this context, another term that could be used for “frame” is “window”.

Typically, full image 20 and sub-image 31 have respective resolutions similar to the respective resolutions of image 4 and sub-image 8 in FIG. 1. Full image 20, further typically, has a fixed resolution representing a portion of an overall scene, so that when it is desirable to view an additional portion of the overall scene, full image 20 is refreshed to display the additional (new) portion of the overall scene. The resolution of sub-image 31 may be two, three, four or more times higher than that of full image 20. The resolution of sub-image 31 may be increased in a continuous fashion, limited only by the quality of an optical zoom subsystem (not shown in the figure, but described hereinbelow).

Operation of the full image display and second display devices is coordinated by a registration subsystem 36 so that when frame 33 is translated over full image 20, high resolution sub-image 31 is displayed with registration maintained between the respective images, aligning the frame and high resolution sub-image 31 within full image 20. The contour and dimensions of frame 33 may be changed, allowing a larger or smaller portion of high resolution sub-image 31 to be displayed within the frame and/or with varying resolution and/or zooming of sub-image 31 within the frame. “Contour” as used herein is the shape of the frame. Changing contour and/or dimensions of frame 33 may be useful, for example, when it is desirable to view a feature of full image 20 that may have been initially blocked by frame 33. In this specific case, sub-image 31 would be retained in its entirety, but a portion of it could be “removed” by adjusting the contour to allow viewing an additional portion of full image 20 in its stead. Methods for accomplishing this are described hereinbelow.

Furthermore, frame 33 may be rotated in relation to full image 20. Rotation of frame 33 can be achieved by mechanically rotating second display device 30 and/or by an optomechanical rotation (such as by using a dove prism, mirrors, etc.). Frame 33 can also be rotated digitally; in which case the resolution of rotated sub-image 31 may be lower than that of the original image, to allow the rotated sub-image to be completely included in frame 33. The frame size and/or its contour may be additionally and optionally automatically changed upon frame rotation to enable a correct display of sub-image 31. Exemplary methods for translating, rotating, changing contour, and changing dimensions of frame 33 include clicking and dragging one or more points on frame 33 using a joystick, as is similarly accomplished with various graphics software, and/or through the use of any other similar image-human-interface devices allowing graphic manipulations.

Registration subsystem 36, in addition to controlling precision gimbals 34, controls respective optomechanical assemblies (not shown) of full image display device 15 and of second display device 30, coordinating processed high resolution sub-image 31 and full image 20 for displaying. Translation of sub-image 31 may be by gimbaled motion or by linear displacement. These options can be implemented either by moving second display device 30 (which could be a projector) or by moving only optical elements (e.g. mirrors). Distortions introduced by the geometry/optics of the translation mechanisms can be corrected by conventional distortion correcting techniques, either optically or digitally. Translation of frame 33 may be slaved to an external device (such as a high resolution camera), it may be directly controlled by a user (e.g., for examining static data), or it may be a combination of the two methods (e.g., user controllable viewing within a region currently within a field of view of a camera). One method of translating full image 20 by the operator is by translating and maintaining frame 33 against an edge of full image 20 for a number of seconds, whereupon full image 20 will refresh and translate one or more frames in the desired direction.

Combined-resolution display work format system 10 may also include more than one of second display device 30, which are coordinated by registration subsystem 36, so that more than one high resolution sub-image may be displayed, as described hereinabove, mutatis mutandis. The display devices and work format surface 25 may be, respectively, projectors and a work-format screen; in which case, projection of images may be in front of and from behind the screen. Full image 20 and sub-image 31 may be derived from a common high resolution data source or from different sources, consisting of but not limited to: sampled images from a camera or other imaging device; simulated images; and graphic displays such used in computer aided design (CAD). Full image 20 may be fixed (i.e. “frozen”) or a dynamically varying image. Sub-image 31 may be obtained from static data or it may be dynamically sampled from an imaging system.

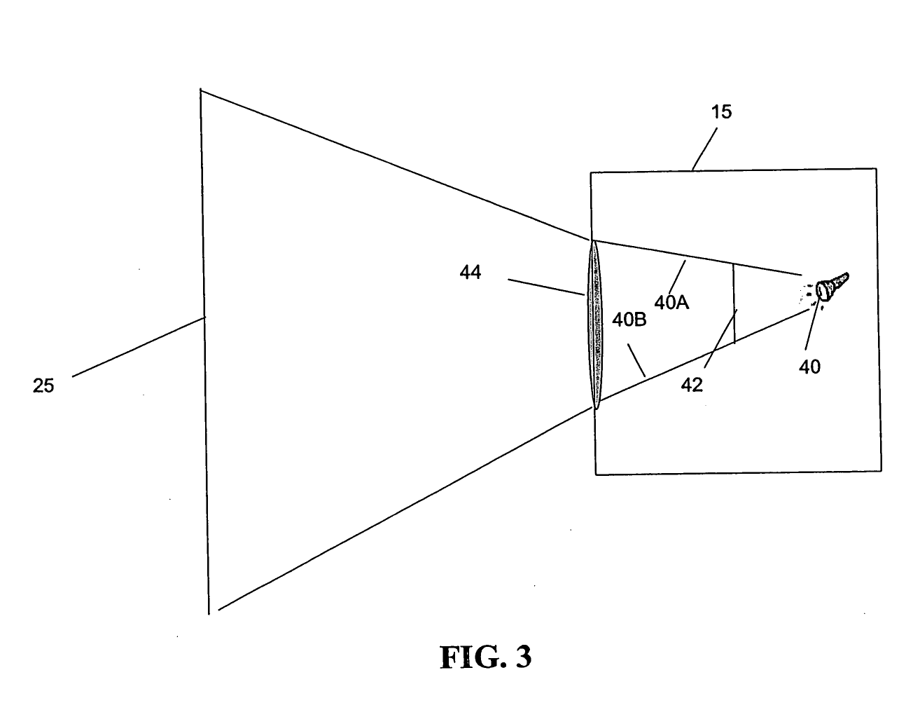

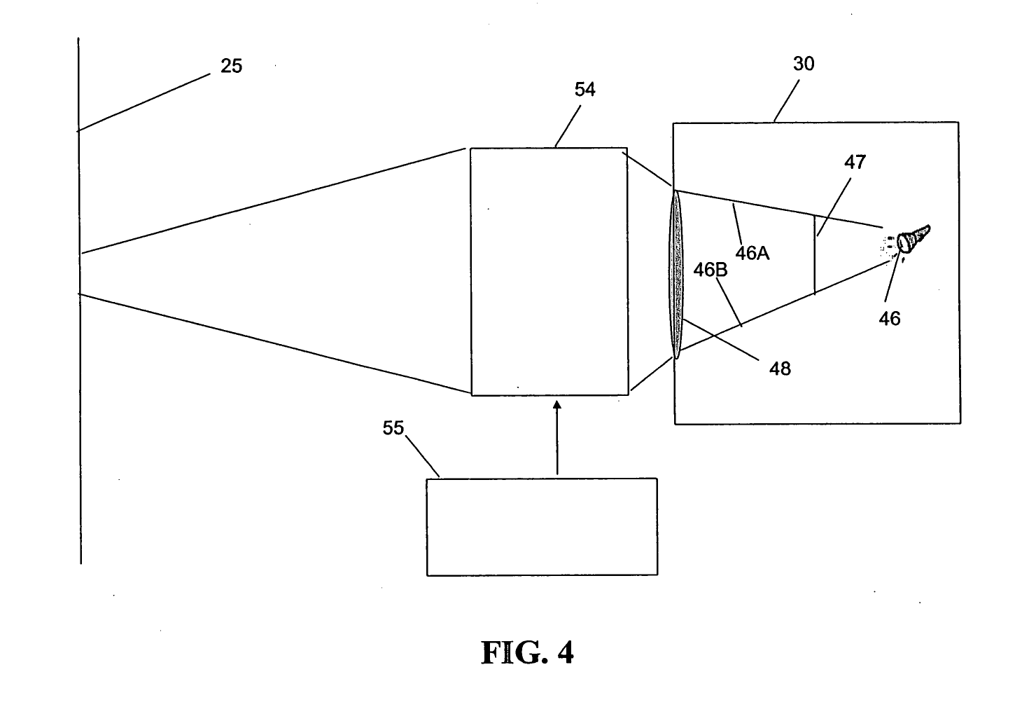

Reference is now made to FIGS. 3 and 4, which are schematic side views of parts of the combined-resolution display work format system shown in FIG. 2. Full image display device 15 includes a projection lamp 40 which projects the full image, schematically indicated by diverging lines 40A and 40B, through a video filter 42 and then through a projector lens 44. The full image is then projected onto work format surface 25. Second display device 30 includes a projection lamp 46 which projects the high resolution sub-image, schematically indicated by diverging lines 46A and 46B, through a video filter 48, through a projector lens 48, and then through registration subsystem 36 (shown in FIG. 2.) An optical zoom subsystem 54, which may comprise optical lenses, prisms, reflecting surfaces, and appropriate mechanical control, is controlled by a zoom computer 55. The high resolution sub-image is then projected onto work format surface 25.

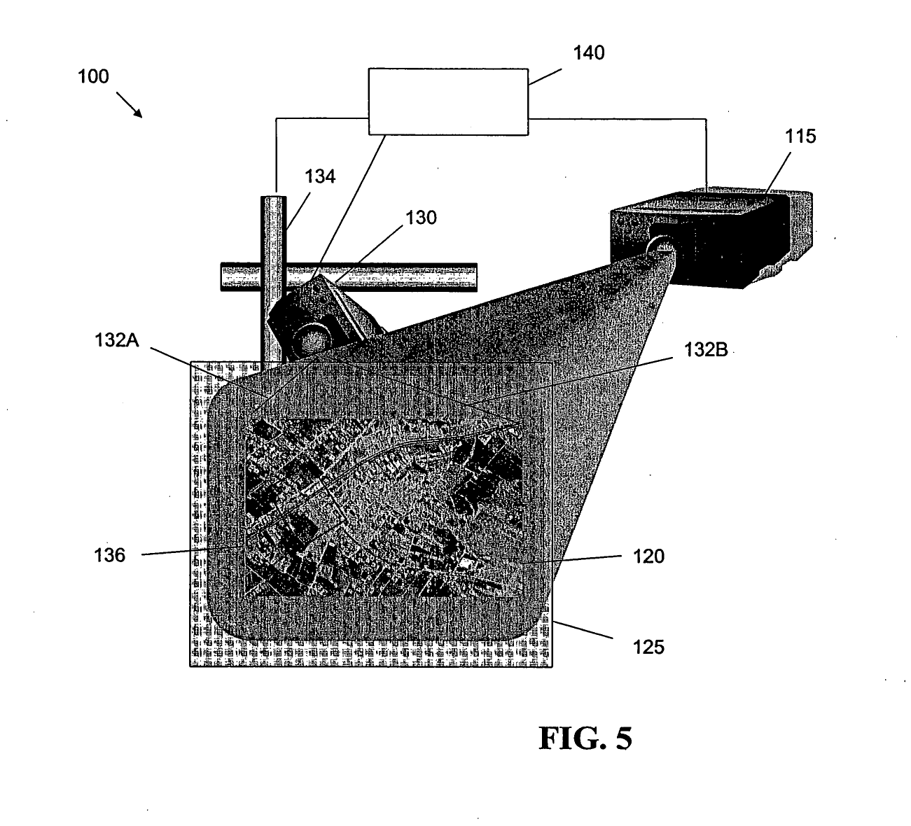

Reference is now made to FIG. 5, which is a schematic diagram of a high resolution display system 100, in accordance with an embodiment of the current invention. High resolution system 100 includes a first display device 115 which displays an image 120 onto a surface 125. A second display device 130, mounted on precision gimbals 134, displays an image indicated by lines 132A and 132B. The image indicated by lines 132A and 132B is the same as image 120; however the image displayed by second display device 130 is aligned with image 120, but has a sub-pixel offset. The sub-pixel offset of the two respective images enhances resolution, yielding a higher resolution image 136. The pixel values in the image having the sub-pixel offset may be calculated a number of ways, although one straightforward method is to calculate individual pixel values based upon the arithmetic average of the values of the four pixels surrounding a given sub-pixel offset coordinate.

Optoelectronic operation of the first and second image display devices, to yield high resolution image 136, is coordinated by an offset control subsystem 140. Additional second display devices may be used and controlled by offset control subsystem 140, displaying additional images aligned with image 120, but having respective sub-pixel offsets, further enhancing resolution of higher resolution image 136.

The first and second display devices and surface 125 may be, respectively, projectors and a screen; in which case, projection of images may be in front of and from behind the screen. Enhanced resolution of higher resolution image 136 may be especially useful in representing textual information or other features and images having the sharpness of typical higher resolution printers.

It will be appreciated that the above descriptions are intended only to serve as examples, and that many other embodiments are possible within the scope of the present invention as defined in the appended claims.

What is claimed is:

1. A combined-resolution display system comprising:
(a) a surface for displaying images;
(b) a first display device adapted to display a first image, having a first resolution, on substantially all of the surface;
(c) at least one second display device adapted to display a second image having a second resolution greater than the first resolution, the second image being a representation of a region included in the first image, the second image displayable within a frame displayable on a portion of the surface in spatial registration with the first image so as to produce a combined mixed resolution image on the surface; and
(d) a registration subsystem adapted to coordinate operation of the first display device and the at least one second display device and to maintain registration between the respective images, aligning the second image within the first image while allowing at least one of: the frame being translated; the frame being rotated; the contour of the frame being changed; and the dimensions of the frame being changed.

2. The combined-resolution display system of claim 1 wherein the registration subsystem is further adapted so that the at least one of: the frame being translated; the frame being rotated; the contour of the frame being changed; and the dimensions of the frame being changed is optomechanically performed.

3. The combined-resolution display system of claim 1 wherein the registration subsystem is further adapted so that the at least one of: the frame being translated; the frame being rotated; the contour of the frame being changed; and the dimensions of the frame being changed is performed using image processing.

4. The combined-resolution display system of claim 1 wherein the registration subsystem is further adapted so that the at least one of: the frame being translated; the frame being rotated; the contour of the frame being changed; and the dimensions of the frame being changed is performed optomechanically and using image processing.

5. A combined-resolution display system comprising:
(a) a surface for displaying images;
(b) a first display device adapted to display a first image, having a first resolution, on substantially all of the surface;
(c) at least one second display device adapted to display a second image having a second resolution greater than the first resolution, the second image being a representation of a region included in the first image, the second image displayable on a portion of the surface in spatial registration with the first image so as to produce a combined mixed resolution image on the surface; and
(d) a varying resolution subsystem adapted to coordinate operation of the first display device and the at least one second display device so that the resolution of the second image may be varied, while maintaining registration between the respective images, aligning the second image within the first image.

6. The combined-resolution display system of claim 5, wherein the second resolution is at least two times larger than the first resolution.

7. A combined-resolution display system comprising:
(a) a surface for displaying images;
(b) a first display device adapted to display a first image, having a first resolution, on substantially all of the surface;
(c) at least one second display device adapted to display a second image having a second resolution at least two times larger than that of the first resolution, the second image being a representation of a region included in the first image, and the second image is displayable on a portion of the surface in spatial registration with the first image so as to produce a combined mixed resolution image on the surface.

8. A high resolution display system comprising:
(a) a surface for displaying images;
(b) a first display device adapted to display a first image on substantially all of the surface;
(c) at least one second display device adapted to display a second image, wherein the second image is aligned with the first image, having a non-zero sub-pixel offset; and
(d) an offset control subsystem adapted to coordinate optoelectronic operation of the first display device and the at least one second display device so that a combined high resolution image is displayable on the surface.

9. The combined resolution display system of claim 8, wherein the first display device and the at least one second display device are projectors.

10. A method of displaying combined-resolution images on a surface comprising the steps of:
(a) providing a first display device to display a first image, having a first resolution, on substantially all of the surface;
(b) using at least one second display device to display a second image having a second resolution greater than the first resolution, the second image being a representation of a region included in the first image;
(c) displaying the second image within a frame displayed on a portion of the surface in spatial registration with the first image so as to produce a combined mixed resolution image on substantially all of the surface; and
(d) coordinating operation of the first display device and the at least one second display device and maintaining registration between the respective images, aligning the second image within the first image while allowing at least one of: translation of the frame; rotation of the frame; changing the contour of the frame; and changing the dimensions of the frame.

11. A method of displaying combined-resolution images on a surface comprising the steps of:
(a) providing a first display device to display a first image, having a first resolution, on substantially all of the surface;
(b) using at least one second display device to display a second image having a second resolution greater than the first resolution, the second image being a representation of a region included in the first image;
(c) displaying the second image on a portion of the surface in spatial registration with the first image so as to produce a combined mixed resolution image on the surface; and
(d) coordinating operation of the first display device and the at least one second display device so that the resolution of the second image may be varied, while maintaining registration between the respective images, aligning the second image within the first image.

12. A method of displaying combined-resolution images on a surface comprising the steps of:
(a) providing a first display device to display a first image, having a first resolution, on substantially all of the surface;
(b) using at least one second display device to display a second image having a second resolution that is at least two times larger than the first resolution, the second image being a representation of a region included in the first image; and
(c) displaying the second image on a portion of the surface in spatial registration with the first image so as to produce a combined mixed resolution image on the surface.

13. A method of displaying high resolution images on a surface comprising the steps of:
(a) providing a first display device to display a first image on substantially all of the surface;
(b) using at least one second display device to display a second image, wherein the second image is aligned with the first image, having a non-zero sub-pixel offset; and
(c) coordinating optoelectronic operation of the first display device and the at least one second display device with an offset control subsystem so that a combined high resolution image is displayed on the surface.
